(19) United States
(12) Patent Application Publication
(10) Pub. No.: US 2017/0187446 A1
(43) Pub. Date: Jun. 29, 2017

(54) Operating Mode Detection in Wireless Range Extenders

(71) Applicant: QUALCOMM Incorporated, San Diego, CA (US)

(72) Inventors: Brian Michael Buesker, San Diego, CA (US); Peerapol Tinnakornsrisuphap, San Diego, CA (US); Krishnakumar Muthusamy, San Jose, CA (US)

(21) Appl. No.: 15/064,858

(22) Filed: Mar. 9, 2016

Related U.S. Application Data
(60) Provisional application No. 62/271,734, filed on Dec. 28, 2015.

(51) Int. Cl. H04B 7/155

(52) U.S. Cl. CPC H04B 7/15507

(57) ABSTRACT

Various embodiments include methods for selecting operating modes on a range extender capable of operating in a plurality of operating modes. Various embodiment methods may include determining whether the range extender has received interoperability information from an access point indicating at least one operating mode of the access point, and selecting an operating mode from the plurality of operating modes of the range extender based on the interoperability information in response to determining that the range extender has received the interoperability information from the access point.

### RELATED APPLICATIONS

This application claims the benefit of priority to U.S. Provisional Patent Application No. 62/271,734 entitled “Operating Mode Detection in Wireless Range Extenders” filed Dec. 28, 2015, the entire contents of which are incorporated herein by reference.

### BACKGROUND

In a wireless network (e.g., a wireless local area network, or WLAN), a wireless client device (e.g., a wireless station) may establish a wireless association (i.e., “associate”) with a wireless access point (access point). A wireless network may include two or more access points. Often, a router is connected to a cable modem or digital subscriber line (DSL) modem to provide access to a broadband network. The router may provide broadband network access for one or more access points. Additionally, range extenders can be used to extend coverage throughout the wireless network. A range extender may operate similar to an access point by receiving, buffering and then relaying data to and from another access point. In some wireless networks, an access point or range extender may operate in a 2.4 GHz frequency band, a 5 GHz frequency band, or in both the 2.4 GHz frequency band and the 5 GHz frequency band.

Access point and range extender devices may be sold separately to consumers, and thus a consumer may purchase an access point and a range extender produced by different vendors. A range extender may be designed for interoperability with various different types of access points. However, such a range extender may not be able to take advantage of all the features of a particular access point and so there may be performance drawbacks. A consumer may purchase a range extender and an access point from the same vendor to increase performance, but the range extender may not work properly when associated with an access point from a different vendor.

### SUMMARY

Various embodiments include methods implemented on a range extender that is capable of operating in a plurality of operating modes for automatically selecting a particular operating mode of the range extender for use with an access point. Various embodiments may include determining, by a processor of the range extender, whether the range extender has received interoperability information from an access point that indicates at least one operating mode of the access point, and selecting, by the processor, an operating mode from the plurality of operating modes of the range extender based on interoperability information received from the access point.

Some embodiment methods may further include transmitting an association request from the range extender to the access point, in which the interoperability information is received in response to the transmitted association request. In some embodiments, the received interoperability information may be contained in an association response message, a probe response, or a beacon frame transmitted by the access point.

In some embodiments, the at least one operating mode of the access point may include a three-address mode and a four-address mode, and selecting an operating mode from the plurality of operating modes of the range extender based on the received interoperability information may include selecting the four-address mode on the range extender. In some embodiments, the at least one operating mode of the access point may include a three-address mode, and selecting an operating mode from the plurality of operating modes of the range extender based on the received interoperability information may include selecting the three-address mode on the range extender.

Some embodiment methods may further include determining, by the processor, whether the access point is capable of one or more additional operating mode features from the received interoperability information, and triggering, by the processor, at least one of the one or more additional operating mode features on the range extender in response to determining that the access point is capable of the one or more additional operating mode features. In some embodiments, the one or more additional operating mode features may include at least one of access point steering, band steering, multi-backhaul connectivity, and improved roaming. Some embodiment methods may further include selecting, by the processor, a default operating mode from the plurality of operating modes of the range extender in response to determining that the range extender has not received the interoperability information from the access point.

Various embodiments include methods implemented on an access point for transmitting interoperability information to a range extender. Various embodiments may include receiving an association request from a range extender, and transmitting interoperability information to the range extender in response to receiving the association request, in which the interoperability information indicates at least one operating mode of the access point.

In some embodiments, transmitting interoperability information to the range extender may include transmitting the interoperability information in an association response message, a probe response, or a beacon frame. In some embodiments, the at least one operating mode of the access point may include a three-address mode and a four-address mode. Some embodiment methods may further include receiving, from the range extender, a selected operating mode of the range extender based on the transmitted interoperability information, in which the range extender is capable of operating in a plurality of operating modes including the selected operating mode. In some embodiments, the interoperability information may further indicate one or more additional operating mode features of the access point. In some embodiments, the one or more additional operating mode features may include at least one of access point steering, band steering, multi-backhaul connectivity, and improved roaming.

Further embodiments include a range extender including a processor configured with processor-executable instructions to perform operations of the methods summarized above. Further embodiments include a non-transitory processor-readable storage medium having stored thereon processor-executable software instructions configured to cause a processor of a range extender to perform operations of the methods summarized above. Further embodiments include a range extender that includes means for performing functions of the operations of the methods summarized above.

Further embodiments may include a range extender capable of operating in a plurality of operating modes that includes means for determining whether the range extender has received interoperability information from an access point that indicates at least one operating mode of the access point, and means for selecting an operating mode from the plurality of operating modes of the range extender based on interoperability information received from the access point.

In some embodiments, the range extender may further include means for transmitting an association request from the range extender to the access point, in which the interoperability information is received in response to the transmitted association request. In some embodiments, the received interoperability information may be contained in an association response message, a probe response, or a beacon frame transmitted by the access point.

In some embodiments, the at least one operating mode of the access point may include a three-address mode and a four-address mode, and the means for selecting an operating mode from the plurality of operating modes of the range extender based on the received interoperability information may include means for selecting the four-address mode on the range extender. In some embodiments, the at least one operating mode of the access point may include a three-address mode, and the means for selecting an operating mode from the plurality of operating modes of the range extender based on the received interoperability information may include means for selecting the three-address mode on the range extender.

In some embodiments, the range extender may further include means for determining whether the access point is capable of one or more additional operating mode features from the received interoperability information, and means for triggering at least one of the one or more additional operating mode features on the range extender in response to determining that the access point is capable of the one or more additional operating mode features. In some embodiments, the one or more additional operating mode features may include at least one of access point steering, band steering, multi-backhaul connectivity, and improved roaming. In some embodiments, the range extender may further include means for selecting a default operating mode from the plurality of operating modes of the range extender in response to determining that the range extender has not received the interoperability information from the access point.

Further embodiments may include an access point for transmitting interoperability information to a range extender that includes means for receiving an association request from a range extender, and means for transmitting interoperability information to the range extender in response to receiving the association request, in which the interoperability information indicates at least one operating mode of the access point.

In some embodiments, the means for transmitting interoperability information to the range extender may include means for transmitting the interoperability information in an association response message, a probe response, or a beacon frame. In some embodiments, the at least one operating mode of the access point may include a three-address mode and a four-address mode. In some embodiments, the access point may further include means for receiving, from the range extender, a selected operating mode of the range extender based on the transmitted interoperability information, in which the range extender is capable of operating in a plurality of operating modes including the selected operating mode. In some embodiments, the interoperability information may further indicate one or more additional operating mode features of the access point. In some embodiments, the one or more additional operating mode features may include at least one of access point steering, band steering, multi-backhaul connectivity, and improved roaming.

Further embodiments may include a non-transitory computer readable storage medium having stored thereon processor-executable software instructions configured to cause a processor of a range extender to perform operations including determining whether the range extender has received interoperability information from an access point that indicates at least one operating mode of the access point, in which the range extender is capable of operating in a plurality of operating modes, and selecting an operating mode from the plurality of operating modes of the range extender based on interoperability information received from the access point.

In some embodiments, the stored processor-executable software instructions may be configured to cause the processor to perform operations further including transmitting an association request from the range extender to the access point, in which the interoperability information is received in response to the transmitted association request. In some embodiments, the received interoperability information may be contained in an association response message, a probe response, or a beacon frame transmitted by the access point.

In some embodiments, the at least one operating mode of the access point may include a three-address mode and a four-address mode, and the stored processor-executable software instructions may be configured to cause the processor to perform operations such that selecting an operating mode from the plurality of operating modes of the range extender based on the received interoperability information may include selecting the four-address mode on the range extender. In some embodiments, the at least one operating mode of the access point may include a three-address mode, and the stored processor-executable software instructions may be configured to cause the processor to perform operations such that selecting an operating mode from the plurality of operating modes of the range extender based on the received interoperability information may include selecting the three-address mode on the range extender.

In some embodiments, the stored processor-executable software instructions may be configured to cause the processor to perform operations further including determining whether the access point is capable of one or more additional operating mode features from the received interoperability information, and triggering at least one of the one or more additional operating mode features on the range extender in response to determining that the access point is capable of the one or more additional operating mode features. In some embodiments, the one or more additional operating mode features may include at least one of access point steering, band steering, multi-backhaul connectivity, and improved roaming. In some embodiments, the stored processor-executable software instructions may be configured to cause the processor to perform operations further including selecting a default operating mode from the plurality of operating modes of the range extender in response to determining that the range extender has not received the interoperability information from the access point.

Further embodiments may include a non-transitory computer readable storage medium having stored thereon processor-executable software instructions configured to cause a processor of an access point to perform operations including receiving an association request from a range extender, and transmitting interoperability information to the range extender in response to receiving the association request, in which the interoperability information indicates at least one operating mode of the access point.

In some embodiments, the stored processor-executable software instructions may be configured to cause the processor to perform operations such that transmitting interoperability information to the range extender may include transmitting the interoperability information in an association response message, a probe response, or a beacon frame. In some embodiments, the at least one operating mode of the access point may include a three-address mode and a four-address mode. In some embodiments, the stored processor-executable software instructions may be configured to cause the processor to perform operations further including receiving, from the range extender, a selected operating mode of the range extender based on the transmitted interoperability information, in which the range extender is capable of operating in a plurality of operating modes including the selected operating mode. In some embodiments, the interoperability information may further indicate one or more additional operating mode features of the access point. In some embodiments, the one or more additional operating mode features may include at least one of access point steering, band steering, multi-backhaul connectivity, and improved roaming.

Further embodiments include an access point including a processor configured with processor-executable instructions to perform operations of the methods summarized above. Further embodiments include a non-transitory processor-readable storage medium having stored thereon processor-executable software instructions configured to cause a processor of an access point to perform operations of the methods summarized above. Further embodiments include an access point that includes means for performing functions of the operations of the methods summarized above.

### BRIEF DESCRIPTION OF THE DRAWINGS

The accompanying drawings, which are incorporated herein and constitute part of this specification, illustrate various embodiments, and together with the general description and the detailed description given herein, serve to explain the features of the claims.

FIG. 1 is a communication system block diagram of a wireless network suitable for use with various embodiments.

FIGS. 2A-2B are block diagrams of example access points suitable for use in accordance with various embodiments.

FIGS. 3A-3B are block diagrams of an example range extender suitable for use in accordance with various embodiments.

FIG. 4 is a process flow diagram illustrating methods for transmitting interoperability information from an access point in accordance with various embodiments.

FIGS. 5A-5B are process flow diagrams illustrating methods for selecting operating modes on a range extender in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

The various embodiments include methods and wireless devices implementing methods for enabling range extender (RE) devices to automatically configure to communicate with an access point (AP). In various embodiments, a range extender activated in range of an access point may communicate with the access point, such as transmitting an association request. In response, the access point may transmit interoperability information that the range extender may receive. The interoperability information may indicate at least one operating mode of the access point. The range extender may operate in a plurality of operating modes. Using the received access point interoperability information, the range extender may select an operating mode that is compatible with the access point. For example, the range extender may select an operating mode and additional features that increase performance and/or interoperability with the access point, and may also disable features that do not increase performance with the access point. In some embodiments, if the access point does not transmit interoperability information, the range extender may select a default operating mode.

As used herein, the term “wireless client device”, “wireless device,” and “client device” refers to any one or all of cellular telephones, smart phones, personal or mobile multi-media players, personal data assistants, desktop computers, laptop computers, tablet computers, servers, smart books, smart watches, palm-top computers, wireless electronic mail receivers, multimedia Internet-enabled cellular telephones, wireless gaming controllers, and similar personal or enterprise electronic devices that includes a programmable processor, memory, and circuitry capable of connecting to a broadband network, such as the Internet, through an access point and/or range extender. Additionally, the term “range extender” may refer to, e.g., Wi-Fi repeaters, boosters, extenders, and other similar devices.

A wireless client device may access resources on a network by communicatively coupling (e.g., associating, registering, or establishing a wireless association in accordance with an association protocol) with an access point of a wireless network. An access point typically has a certain range in which the signal is sufficiently strong to support a network connection for the wireless client device. Outside of this range, the signal strength of the access point may be too weak to provide a consistently strong connection. A range extender may be used to extend the range of the access point's wireless coverage. The range extender may be located some distance away from the access point but still within the access point's wireless coverage. The range extender may associate with the access point and provide the same wireless connection to wireless client devices that may be closer to the range extender than to the access point or receive better coverage from the range extender than the access point (e.g., higher received signal strength indication (RSSI), better throughput, etc.).

Access points and range extenders may be configured to operate in various modes. For example, one mode of operation may be termed a three-address mode. The three-address mode utilizes three medium access control (MAC) addresses to complete a communication connection between a wireless client device and another source device (e.g., a router, a wired client device, or another wireless client device). The three addresses may include the address of the source (e.g., a web server), the address of the destination (e.g., a wireless client device), and the address of the access point.

The three-address mode does not include the address of the destination client device connected to the range extender via a wired or wireless connection, so in order to operate with an access point in three-address mode, the range extender may implement various workarounds. For example, in the data link layer (i.e., layer 2) the range extender may create a virtual MAC address that maps to the actual wireless client device. When this virtual MAC address is utilized in a wireless communication, the range extender recognizes this address and routes the communication to the wireless client device. In another example, the range extender may utilize a network layer (i.e., layer 3) address translation scheme to accommodate communication with clients that are associated with the range extender.

An example of another mode of operation for access points and range extenders is four-address mode. In four-address mode, the MAC address of the destination client device connected to the range extender via a wired or wireless connection may be included in the wireless communication protocol and so there is no need to resort to virtual MAC addresses or address translation. However, some access points may not support four-address mode. Range extenders may be configured for interoperability with various access points, and so may be configured to operate in three-address mode or four-address mode. Certain performance or interoperability issues may arise in three-address mode. For example, a wireless client device that migrates from the range extender's wireless connection to the access point's wireless connection or vice versa may be assigned a different Internet Protocol (IP) address. This may cause problems for applications on the wireless client device that utilize the old IP address (e.g., may require restart of the application). Also, if the range extender is configured to operate in four-address mode, the range extender may not work properly with access points that operate in three-address mode. Thus, mismatches between the operating modes of the access point and range extender may cause performance or interoperability issues.

In overview, various embodiments provide systems and methods for automatically selecting operating modes on a range extender capable of operating in a plurality of operating modes. A processor in the range extender may be configured to receive interoperability information from an access point indicating at least one operating mode of the access point, and select an operating mode from the plurality of operating modes of the range extender based on the interoperability information. The interoperability information of the access point may indicate that the access point can operate in three-address mode and/or in four-address mode. If the access point does not transmit interoperability information to the range extender, the range extender may select a default operating mode (e.g., three-address mode). In this manner, the range extender may operate in different modes depending on the capabilities of the access point.

Various embodiments also provide systems and methods transmitting interoperability information from an access point to a range extender. A processor in the access point may be configured to receive an association request from a range extender and transmit interoperability information to the range extender in response to receiving the association request. The interoperability information may include at least one operating mode of the access point, such as the three-address mode and/or the four-address mode. The interoperability information may be included, for example, in an association response message, a probe response, or a beacon frame transmitted by the access point.

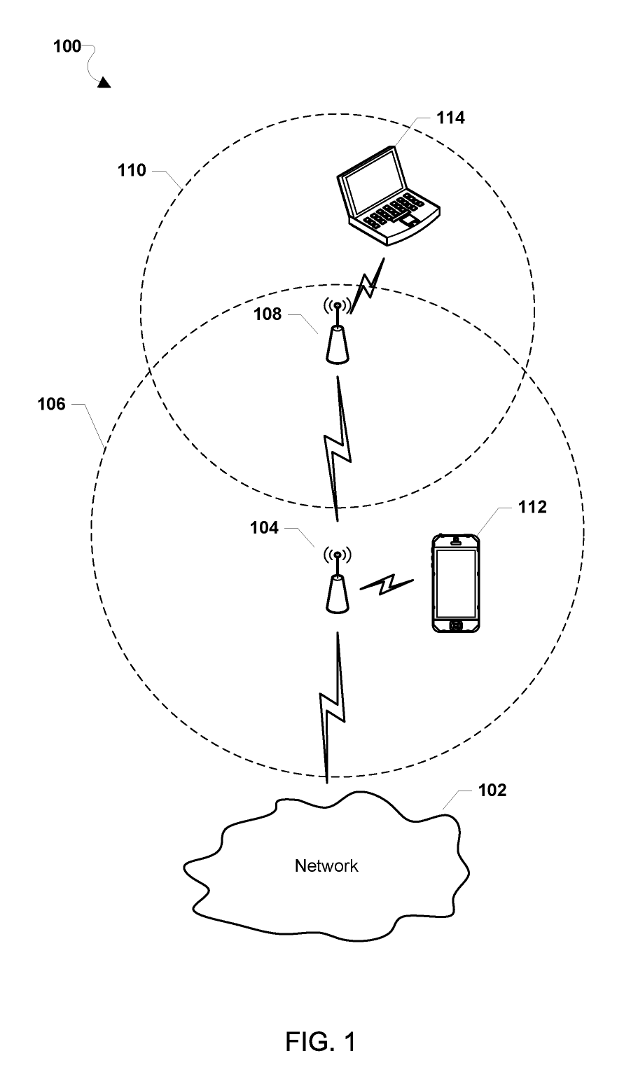

Various embodiments may be implemented within a variety of wireless networks, an example of which is illustrated in FIG. 1. A wireless network 100 may include an access point 104, which may provide wireless coverage (e.g., Wi-Fi coverage) to a first wireless client device 112 for connecting to a network 102, such as the Internet or another broadband network. The access point 104 may have a wireless coverage range 106, and the first wireless client device 112 is within the wireless coverage range 106.

The wireless network 100 may also include a range extender 108, which extends the wireless coverage of the access point 104. The range extender 108 may be located within the wireless coverage range 106 and may associate with the access point 104. The range extender 108 may extend wireless coverage to an extended wireless range 110. A second wireless client device 114 may be located outside of the wireless coverage range 106 but inside the extended wireless range 110. The second wireless client device 114 may connect to the range extender 108 to gain access to the network 102. The wireless network 100 may include other devices and components not illustrated in FIG. 1, such as additional access points, range extenders, and wireless client devices.

The access point 104 may be configured to operate in one or more operating modes. For example, the access point 104 may be configured to operate in three-address mode, or in four-address mode to implement a wireless distribution system (WDS). The access point 104 may also support additional operating mode features, capabilities, and protocols, such as access point steering, band steering, load balancing, multi-backhaul connectivity, and/or improved roaming.

Access point steering may include directing wireless client devices to either a range extender or an access point depending on the wireless client device's location and/or the load or traffic conditions of the range extender and/or the access point. For example, four wireless client devices in range of both the range extender and the access point may be connected to the range extender, while no devices are connected to the access point directly. The aggregate throughput or average connection speed of the wireless client devices may be slower than possible because all of the devices are utilizing the resources of the range extender. A range extender and/or access point with access point steering enabled may direct one or more of the wireless client devices to connect to the access point directly, e.g., if the range extender and/or access point observe the aggregate throughput below a threshold or the connection speed of a device is slower than a threshold. This may aid in load balancing between the range extender and the access point so that wireless client devices experience a faster connection speed in aggregate. Additionally or alternatively, load balancing may take into account quality of service (QoS) requirements of traffic to/from a client device. For example, a connection speed of a client device may have a minimum requirement if the device is transmitting and receiving Voice over IP (VoIP), video conferencing, or other time sensitive information. Thus, load balancing may attempt to raise the aggregate throughput of all client devices while still preserving at least the minimum required connection speed for the individual client device.

Band steering may include directing a wireless client device to utilize one of the frequency bands of the range extender or the access point. A range extender may operate, e.g., in at least one of the 900 MHz, 2.4 GHz, 5 GHz, and 60 GHz frequency bands (the following examples are presented discussing the 2.4 and 5 GHz bands for simplicity purposes, but the examples should not limit the disclosure to use of 2.4 and 5 GHz bands). For example, if three wireless client devices are connected to the range extender on the 2.4 GHz frequency band, but no devices are utilizing the 5 GHz frequency band, the connection speed of the wireless client devices may be slower than possible because all the devices are utilizing the 2.4 GHz frequency band with none utilizing the 5 GHz frequency band. In such a situation, a range extender with band steering enabled may direct one or more of the wireless client devices to utilize the 5 GHz frequency band. In some cases, the access point and the range extender may coordinate the band steering to improve reliability for wireless client devices connected to either the range extender or access point. Thus, band steering may aid in load balancing between the frequency bands of the range extender.

Multi-backhaul connectivity may include opening parallel or redundant communication links on multiple frequency bands of the access point or range extender. For example, consider an access point that can operate in both 2.4 GHz and 5 GHz frequency bands. A range extender may open a communication link on the 2.4 GHz frequency band of the access point. A range extender with multi-backhaul connectivity enabled may open a second, parallel communication link to the access point on the 5 GHz frequency band. The two communication links may be used to increase the performance or robustness of the overall connection of the range extender and/or the access point. The two communication links may be in a master-slave relationship in which one communication link is used when the other link fails or may carry different data traffic depending on the conditions. There may also be special bridging rules to prevent forward looping in the local wireless network.

Improved roaming may include preventing excessive connection switching between the range extender and the access point. For example, a wireless client device may be carried by a user between the coverage area of the range extender and the access point (and overlapping areas as well). This movement may cause the wireless client device to repeatedly switch between connecting to the access point and connecting to the range extender. This may cause QoS problems on the wireless client device (e.g., data interruptions to VoIP, video, etc., or misdirected data).

For example, in three-address mode, the wireless client device may be assigned a virtual MAC address when connecting to the range extender. Another device in communication with the wireless client device may utilize the virtual MAC address to direct traffic to the wireless client device. If the wireless client device then switches to the access point, the wireless client device loses the virtual MAC address, which may result in dropping the underlying data traffic sent by the other device. A range extender and/or access point with improved roaming enabled may retain the connection with the wireless client device even if the wireless client device moves closer to another range extender/access point as long as the wireless client device remains within the coverage area. This may prevent excessive connection switching.

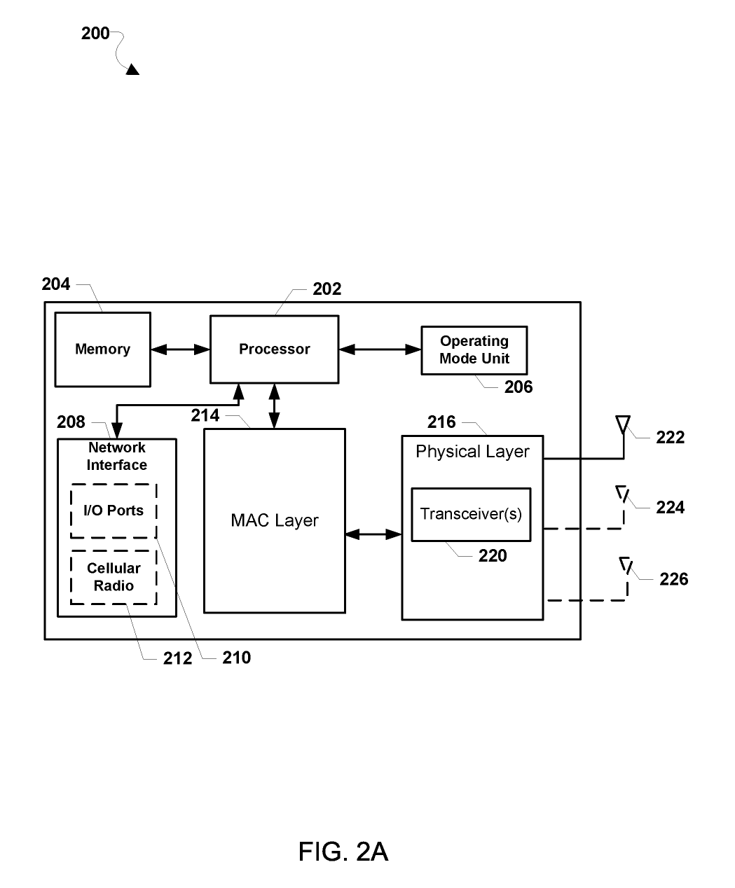

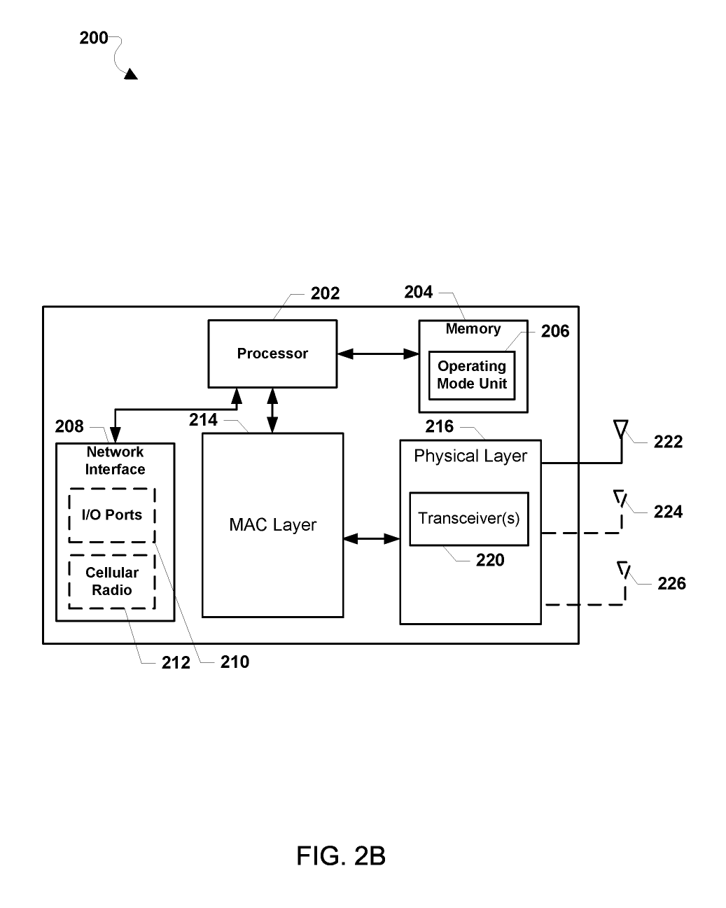

FIGS. 2A-2B are functional block diagrams of an access point 200 suitable for implementing various embodiments. The access point 200 may include at least one controller, such as a processor 202. The processor 202 may also be coupled to the memory 204. The memory 204 may be a non-transitory computer-readable storage medium that stores processor-executable instructions. For example, the memory 204 may include one or more caches, read only memory (ROM), random access memory (RAM), electrically erasable programmable ROM (EEPROM), static RAM (SRAM), dynamic RAM (DRAM), or other types of memory known in the art.

The access point 200 may also include an operating mode unit 206 that may control the operating mode of the access point 200. In some embodiments, the operating mode unit 206 is communicably coupled to the processor 202 as shown in FIG. 2A. In alternative embodiments, the operating mode unit 206 may be instructions stored in memory 204 and executed by the processor 202, as shown in FIG. 2B. Thus, the operating mode unit 206 may be implemented in hardware and/or software. The operating mode unit 206 may configure the access point 200 to operate in a particular mode, such as three-address mode, four-address mode, and enable or disable other additional operating mode features, which may include one or more configurations of access point steering, band steering, load balancing, multi-backhaul connectivity, and/or improved roaming. The operating mode unit 206 may also store interoperability information about the operating mode and additional operating mode features of the access point 200 that may be transmitted to one or more range extenders.

The access point 200 may also include a network interface 208 for connecting to a broadband network, such as the Internet. The access point 200 may provide various computing devices with access to the broadband network. The network interface 208 may include one or more input/output (I/O) ports 210 through which a connection to a network, such as the Internet, may be provided. For example, the I/O ports 210 may include an Ethernet connection, a fiber optic connection, a broadband cable connection, a telephone line connection, or other types of wired communication connections. Alternatively or in addition to the I/O ports 210, the network interface 208 may include a cellular radio unit 212 that provides a connection to a mobile telephony system or cellular data network through which access to the Internet may be acquired.

The processor 202 may each be coupled to a medium access control (MAC) layer 214. The MAC layer 214 may provide addressing and channel access control mechanisms between the network interface 208 and one or more devices associated with the access point 200, such as wireless client devices and/or range extenders. The MAC layer 214 may be connected to a physical layer 216, which may perform various encoding, signaling, and data transmission and reception functions. The physical layer 216 may include one or more transceivers 220 for carrying out the various functions of the physical layer 216. The physical layer 216 may be coupled to one or more wireless antennas (e.g., wireless antennas 222, 224, and 226) used to support wireless communication with devices associated with the access point 200, such as wireless client devices and/or range extenders. Each of the transceivers 220 may utilize a different frequency band for communication (e.g., 900 MHz, 2.4 GHz, 5 GHz, and 60 GHz). The number of wireless antennas in the access point 200 is not limited to three as illustrated in FIGS. 2A-2B, but may include any number of antennas.

The access point 200 may also include a bus for connecting the various components of the access point 200 together. The access point 200 may also include various other components not illustrated in FIGS. 2A-2B. For example, the access point 200 may include a number of input, output, and processing components such as buttons, lights, switches, antennas, display screen or touchscreen, various connection ports, additional processors or integrated circuits, and many other components known in the art.

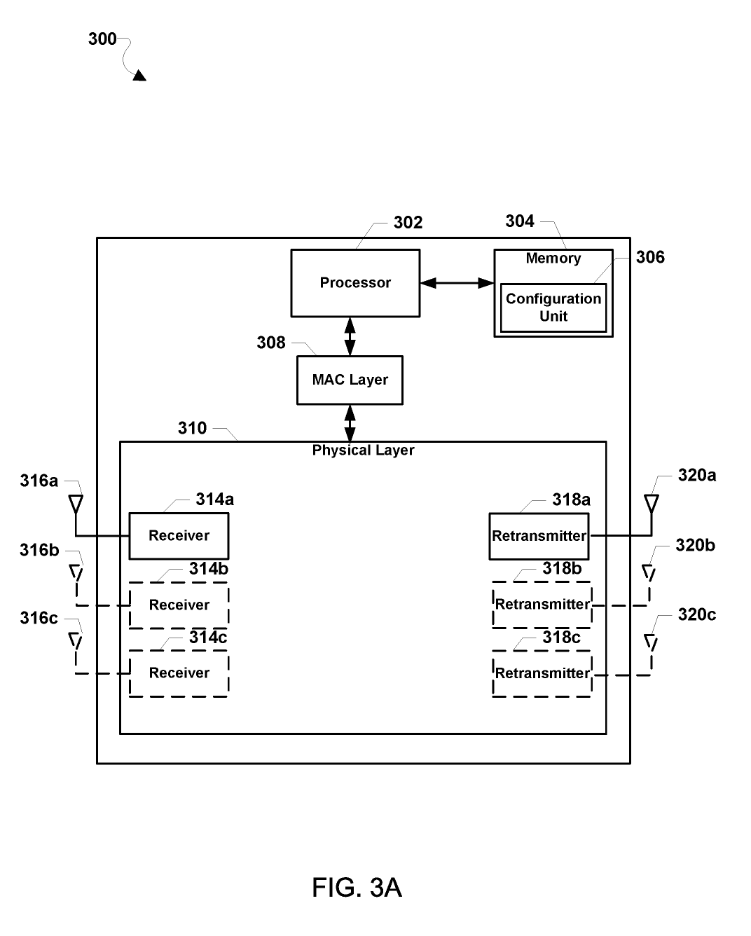

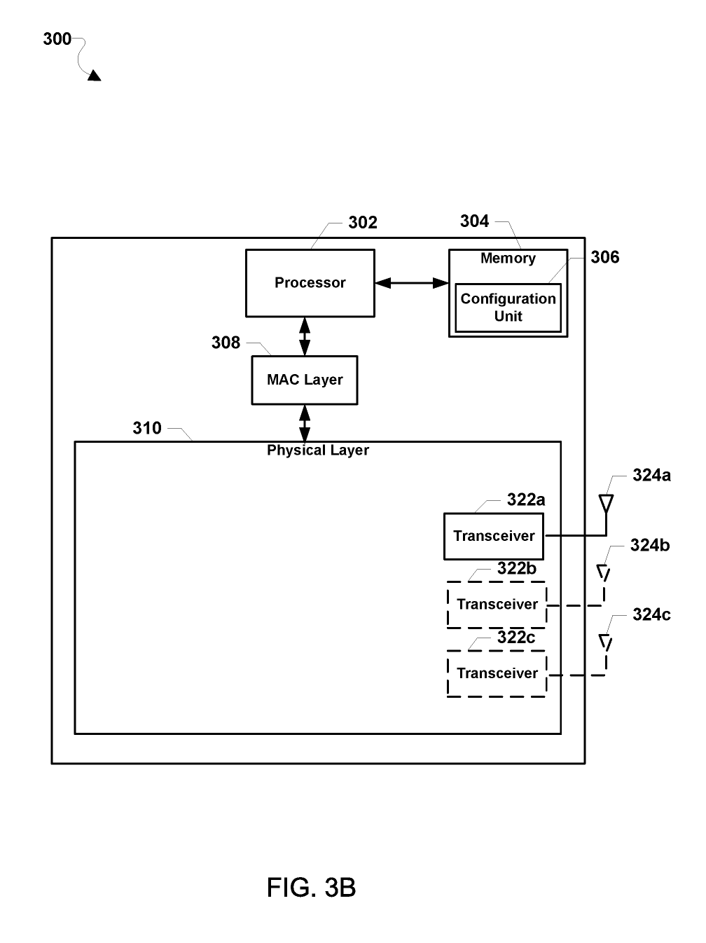

FIGS. 3A-3B are functional block diagrams of a range extender 300 suitable for implementing various embodiments. The range extender 300 may include at least one controller, such as a processor 302. The processor 302 may also be coupled to the memory 304. The memory 304 may be a non-transitory computer-readable storage medium that stores processor-executable instructions. For example, the memory 304 may include one or more caches, read only memory (ROM), random access memory (RAM), electrically erasable programmable ROM (EEPROM), static RAM (SRAM), dynamic RAM (DRAM), or other types of memory known in the art.

The range extender 300 may also include a configuration unit 306 that may control the operating mode of the range extender 300. The configuration unit 306 may be instructions stored in memory 304 and executed by the processor 302 as illustrated in FIGS. 3A and 3B. Alternatively, the configuration unit 306 may be implemented completely in hardware, or partially in hardware and partly as software. The configuration unit 306 may configure the range extender 300 to operate in one of multiple modes based on interoperability information received from an access point (e.g., the access point 200). For example, the configuration unit 306 may configure the range extender 300 to operate in three-address mode if interoperability information received from an access point indicates that the access point operates in three-in three-address mode. In three-address mode, the range extender 300 may implement virtual MAC address mapping or address translation. In another example, the configuration unit 306 may configure the range extender 300 to operate in four-address mode if interoperability information received from an access point indicates that the access point operates in four-address mode, as well as enable any other additional operating mode features enabled by the access point. Such other operating mode features may include details and configurations for access point steering, band steering, load balancing, multi-backhaul connectivity, and/or improved roaming.

Thus, the configuration unit 306 may allow the range extender 300 to match the same operating mode as the access point. In some embodiments, if the access point can operate in multiple operating modes, there may be a preference for a particular operating mode. For example, if both the range extender 300 and the access point 200 can operate in three-address mode or four-address mode, the range extender 300 may preferentially select the four-address mode. In some embodiments, if the access point 200 does not transmit interoperability information to the range extender 300, the configuration unit 306 may select a default operating mode. The default operating mode may be an operating mode that is common to most or all access points, for example three-address mode.

The processor 302 may be coupled to a MAC layer 308. The MAC layer 308 may provide addressing and channel access control mechanisms for coordinating communication links between wireless client devices connected to the range extender 300 and an access point with which the range extender 300 is associated.

The MAC layer 308 may be connected to a physical layer 310, which may perform various encoding, signaling, and data transmission and reception functions on the range extender 300. The physical layer 310 may include one or more receivers 314a-314c and one or more re-transmitters 318a-318c as illustrated in FIG. 3A. The receivers 314a-314c may each receive a broadband network connection signal transmitted from an access point. The receivers 314a-314c may receive signals through one or more wireless antennas 316a-316c. Each receiver 314a-314c may include one or more amplifiers, filters, radios, and other components for performing reception operations. Each receiver 314a-314c may operate on a different base or center frequency. For example, the receivers 314a-314c may receive signals on different frequencies utilized by the transceivers 220 of the access point 200.

In some embodiments, each re-transmitter 318a-318c may re-transmit a broadband network connection signal from a corresponding receiver 314a-314c. Each re-transmitter 318a-318c may transmit the signal to various computing devices through one or more wireless antennas 320a-320c. The frequencies utilized by each re-transmitter 318a-318c may be the same frequencies utilized by the receivers 314a-314c or may be different frequencies.

In alternative embodiments, the functions of the receivers 314a-314c and the re-transmitters 318a-318c may be combined into transceivers 322a-322c and wireless antennas 324a-314c that perform both reception and transmission operations, as illustrated in FIG. 3B. For example, the transceivers 322a-322c may be configured to receive communications from various wireless client devices connected to the range extender 300, as well as receive communications from an access point associated with the range extender 300. The transceivers 322a-322c may also be configured to transmit communications received from the access point to the wireless client devices connected to the range extender 300, and vice versa.

The number of transceivers, receivers, and re-transmitters in the range extender 300 are not limited to three as illustrated in FIGS. 3A-3B, but may include any number of transceivers, receivers, and re-transmitters. There may be a one-to-one correspondence between receivers and re-transmitters, or multiple receivers may share one re-transmitter, or multiple re-transmitters may share one receiver.

The range extender 300 may also include a bus for connecting the various components of the range extender 300 together. The range extender 300 may also include various other components not illustrated in FIGS. 3A-3B. For example, the range extender 300 may include a number of input, output, and processing components such as buttons, lights, switches, antennas, display screen or touchscreen, various connection ports, additional processors or integrated circuits, and many other components known in the art.

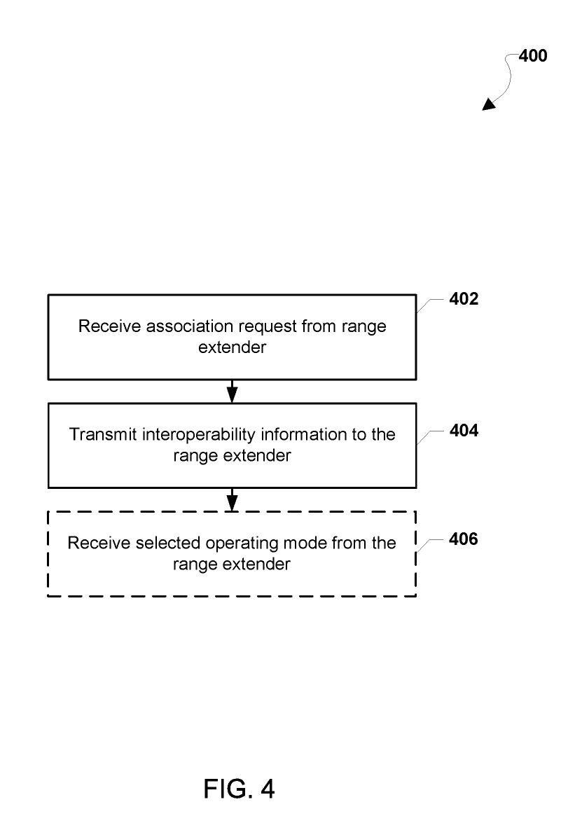

FIG. 4 illustrates a method 400 for transmitting interoperability information from an access point in accordance with various embodiments. The method 400 may be implemented by a processor of a wireless access point device (e.g., the processor 202 of the access point 200 in FIG. 2). The access point may be providing wireless coverage (e.g., Wi-Fi) to connect one or more wireless client devices with a broadband network, such as the Internet.

In block 402, the processor may receive an association request from a range extender. The range extender may be attempting to associate with the access point to provide extended wireless coverage to wireless client devices.

In block 404, the processor may transmit interoperability information of the access point to the range extender. The interoperability information may include information indicating at least one operating mode of the access point, such as three-address mode, four-address mode, and/or other modes of operation, as well as additional operating mode features, which may include details and configurations for access point steering, band steering, load balancing, multi-backhaul connectivity, and/or improved roaming. The interoperability information may be included, for example, in an association response message sent to the range extender in response to the association request. The interoperability information may also be included in other communication messages sent to the range extender, such as a probe response or a beacon frame. The interoperability information may be vendor specific.

In various embodiments, the range extender may be capable of operating in a plurality of operating modes, and may select an operating mode from the plurality of operating modes based on the interoperability information transmitted by the access point. For example, the interoperability information may indicate that the access point can operate in three-address mode and four-address mode. In that case, the range extender may select to operate in four-address mode, and the access point and range extender may become associated using four-address mode.

In optional block 406, the access point may receive a selected operating mode from the range extender. The range extender may transmit the operating mode that it selected to the access point. The range extender may also transmit other information to the access point, for example its own interoperability information.

In this manner, the method 400 provides a way for an access point to provide interoperability information to a range extender to enable increased performance and/or operability between the access point and the range extender.

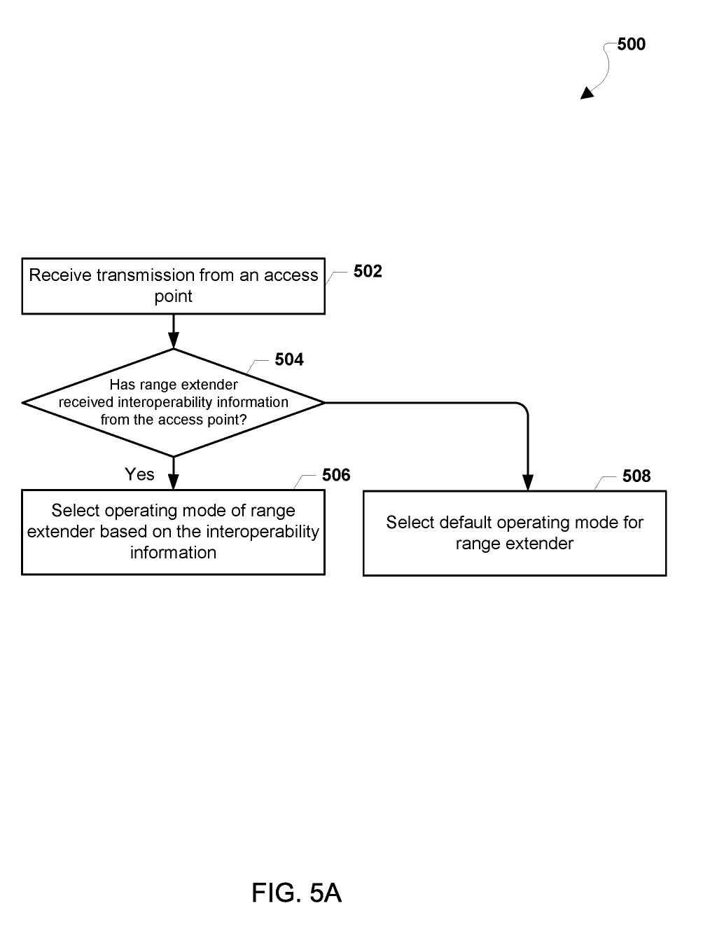

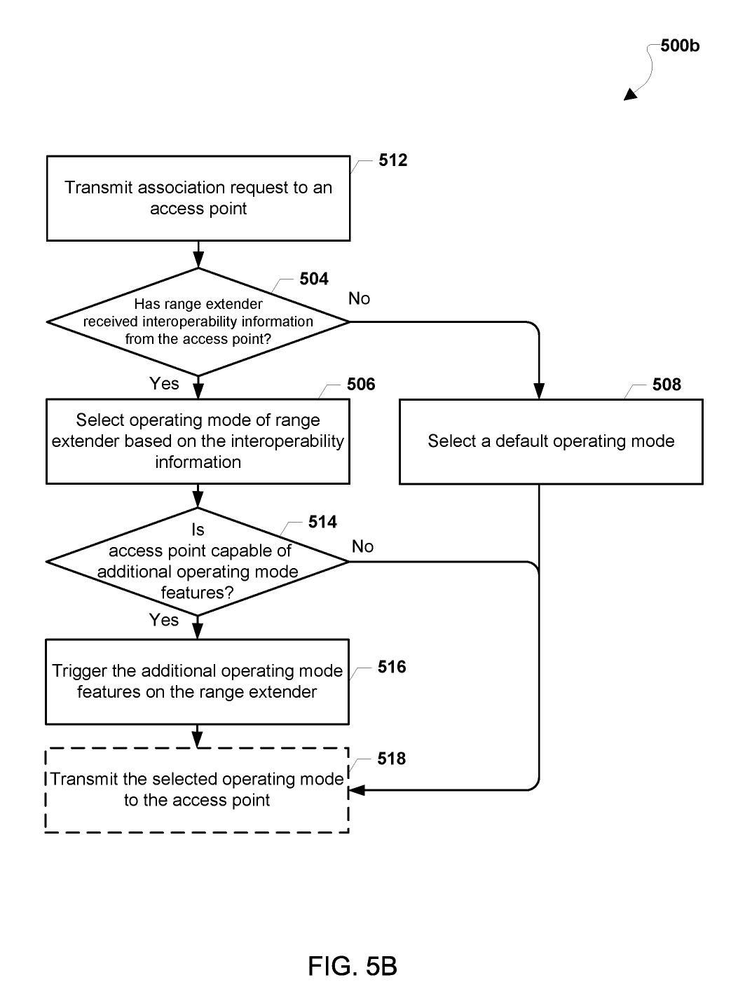

FIG. 5A illustrates a method 500 for selecting operating modes on a range extender in accordance with various embodiments. The method 500 may be implemented by a processor of a wireless range extender device (e.g., the processor 302 of the range extender 300 in FIG. 3). The range extender may be providing extended wireless coverage (e.g., Wi-Fi) in conjunction with an access point to connect one or more wireless client devices with a broadband network, such as the Internet. The range extender may be capable of operating in a plurality of operating modes, such as three-address mode and four-address mode.

In block 502, the range extender may receive a transmission from an access point. Such transmissions may be an association response message sent by the access point after the range extender sends an association request, or another communication message sent from the access point, such as a probe response or beacon frame.

In determination block 504, the processor may determine whether the range extender has received interoperability information of an access point. The interoperability information may be provided in an association response message sent by the access point after the range extender sends an association request, or may be included in other communication messages sent from the access point, such as a probe response or beacon frame. The interoperability information may include information indicating at least one operating mode of the access point, such as three-address mode, four-address mode, and/or other modes of operation, as well as additional operating mode features, which may include details and configurations for access point steering, band steering, load balancing, multi-backhaul connectivity, and/or improved roaming.

In response to determining that the range extender has received interoperability information from the access point (i.e., determination block 504=“Yes”), the processor may select an operating mode from the plurality of operating modes of the range extender based on the interoperability information received from the access point in block 506. For example, if the interoperability information indicates that the access point can operate in three-address mode, the processor may configure the range extender to also operate in three-address mode. In three-address mode, the range extender may utilize virtual MAC address mapping or address translation. If the interoperability information indicates that the access point is operating in both three-address mode and four-address mode, the processor may configure the range extender to operate in four-address mode. In some embodiments, the range extender may preferentially select certain operating modes over other operating modes (e.g., a preference for four-address mode over three-address mode). Once the operating mode of the range extender is selected, the range extender and the access point may be associated using the selected operating mode.

In response to determining that the range extender has not received interoperability information from the access point (i.e., determination block 504=“No”), the processor may select a default operating mode from the plurality of operating modes of the range extender in block 508. For example, the range extender may default to three-address mode. The range extender and the access point may be associated using the default operating mode.

FIG. 5B illustrates another method 500b for selecting operating modes on a range extender in accordance with various embodiments. The method 500b extends the operations of the range extender as described in the method 500. The method 500b may be implemented by a processor of a wireless range extender device (e.g., the processor 302 of the range extender 300 in FIG. 3). The range extender may be providing extended wireless coverage (e.g., Wi-Fi) in conjunction with an access point to connect one or more wireless client devices with a broadband network, such as the Internet. The range extender may be capable of operating in a plurality of operating modes, such as three-address mode and four-address mode.

In block 512, the processor may transmit an association request to the access point. For example, upon start-up the range extender may be within range of a root access point and attempt to associate with the root access point to provide extended wireless coverage to wireless client devices.

The processor may then perform the operations of determination block 504 and block 506 as described with reference to the method 500. For example, in determination block 504, the processor may determine whether the range extender has received interoperability information of the access point in response to the association request.

In response to determining that the range extender has not received interoperability information from the access point (i.e., determination block 504=“No”), the processor may select a default operating mode from the plurality of operating modes of the range extender in block 508. For example, the access point may not be configured to transmit interoperability information to the range extender. In this case, the range extender may select a default operating mode that is interoperable with most or all access points. For example, the default operating mode may be three-address mode.

In response to determining that the range extender has received interoperability information from the access point (i.e., determination block 504=“Yes”), the processor may select an operating mode from the plurality of operating modes of the range extender based on the interoperability information received from the access point in block 506.

In determination block 514, the processor may determine whether the access point is capable of one or more additional operating mode features from the received interoperability information. The additional operating mode features may include access point steering, band steering, load balancing, multi-backhaul connectivity, and/or improved roaming.

In response to determining that the access point is capable of one or more additional operating mode features from the received interoperability information (i.e., determination block 514=“Yes”), the processor may trigger the one or more additional operating mode features on the range extender in block 516.

In response to determining that the access point is not capable of one or more additional operating mode features from the received interoperability information (i.e., determination block 514=“No”), after selecting a default operating mode in block 508, or after triggering the one or more additional operating mode features in block 516 the processor may optionally transmit the selected operating mode to the access point in block 518.

The method 500 provides a way for a range extender to identify and match the operating mode of an access point to improve performance and/or operability of communications between the range extender and the access point.

The foregoing descriptions of embodiment devices and methods are provided as illustrative examples and are not intended to limit the scope of the claims. For instance, although described examples refer to wireless systems having defined frequency bands in compliance with Institute of Electrical and Electronics Engineers (IEEE) 802.11 specifications, other wireless, wired, or hybrid systems may be used. Also, well-known instruction instances, protocols, structures, and techniques have not been shown in detail in order not to obfuscate the description.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, units, circuits, and algorithm operations described in connection with the embodiments disclosed herein may be implemented as electronic hardware, computer software, or combinations of both. To clearly illustrate this interchangeability of hardware and software, various illustrative components, blocks, units, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, units, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable software that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the memory described herein are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of various embodiments is provided to enable any person skilled in the art to make or use the claims. Various modifications to these embodiments will be readily apparent to those skilled in the art, and the generic principles defined herein may be applied to some embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for automatically selecting operating modes of a range extender capable of operating in a plurality of operating modes, comprising:
determining, by a processor of the range extender, whether the range extender has received interoperability information from an access point that indicates at least one operating mode of the access point; and
selecting, by the processor, an operating mode from the plurality of operating modes of the range extender based on received interoperability information in response to determining that the range extender has received the interoperability information from the access point.

2. The method of claim 1, further comprising transmitting an association request from the range extender to the access point, wherein the interoperability information is received from the access point in response to the association request.

3. The method of claim 1, wherein the received interoperability information is contained in an association response message, a probe response, or a beacon frame transmitted by the access point.

4. The method of claim 1, wherein the at least one operating mode of the access point comprises a three-address mode and a four-address mode, and
wherein selecting an operating mode from the plurality of operating modes of the range extender based on the received interoperability information comprises selecting the four-address mode on the range extender.

5. The method of claim 1, wherein the at least one operating mode of the access point comprises a three-address mode, and
wherein selecting an operating mode from the plurality of operating modes of the range extender based on the received interoperability information comprises selecting the three-address mode on the range extender.

6. The method of claim 1, further comprising:
determining, by the processor, whether the access point is capable of one or more additional operating mode features from the received interoperability information; and
triggering, by the processor, at least one of the one or more additional operating mode features on the range extender in response to determining that the access point is capable of the one or more additional operating mode features.

7. The method of claim 6, wherein the one or more additional operating mode features comprises at least one of access point steering, band steering, multi-backhaul connectivity, and improved roaming.

8. The method of claim 1, further comprising selecting, by the processor, a default operating mode from the plurality of operating modes of the range extender in response to determining that the range extender has not received the interoperability information from the access point.

9. A method for transmitting interoperability information from an access point, comprising:
receiving an association request from a range extender; and
transmitting interoperability information to the range extender in response to receiving the association request, wherein the interoperability information indicates at least one operating mode of the access point.

10. The method of claim 9, wherein transmitting interoperability information to the range extender comprises transmitting the interoperability information in an association response message, a probe response, or a beacon frame.

11. The method of claim 9, wherein the at least one operating mode of the access point comprises a three-address mode and a four-address mode.

12. The method of claim 9, further comprising:
receiving, from the range extender, a selected operating mode of the range extender based on the transmitted interoperability information, wherein the range extender is capable of operating in a plurality of operating modes including the selected operating mode.

13. The method of claim 9, wherein the interoperability information further indicates one or more additional operating mode features of the access point.

14. The method of claim 13, wherein the one or more additional operating mode features comprises at least one of access point steering, band steering, multi-backhaul connectivity, and improved roaming.

15. A range extender, comprising:
a processor configured with processor-executable instructions to perform operations comprising:
determining whether the range extender has received interoperability information from an access point that indicates at least one operating mode of the access point, wherein the range extender is capable of operating in a plurality of operating modes; and
selecting an operating mode from the plurality of operating modes of the range extender based on received interoperability information in response to determining that the range extender has received the interoperability information from the access point.

16. The range extender of claim 15, wherein the processor is configured with processor-executable instructions to perform operations further comprising:
transmitting an association request from the range extender to the access point, wherein the interoperability information is received from the access point in response to the association request.

17. The range extender of claim 15, wherein the received interoperability information is contained in an association response message, a probe response, or a beacon frame transmitted by the access point.

18. The range extender of claim 15, wherein the at least one operating mode of the access point comprises a three-address mode and a four-address mode, and
wherein the processor is further configured with processor-executable instructions to perform operations such that selecting an operating mode from the plurality of operating modes of the range extender based on the received interoperability information comprises selecting the four-address mode on the range extender.

19. The range extender of claim 15, wherein the at least one operating mode of the access point comprises a three-address mode, and
wherein the processor is further configured with processor-executable instructions to perform operations such that selecting an operating mode from the plurality of operating modes of the range extender based on the received interoperability information comprises selecting the three-address mode on the range extender.

20. The range extender of claim 15, wherein the processor is configured with processor-executable instructions to perform operations further comprising:
determining whether the access point is capable of one or more additional operating mode features from the received interoperability information; and
triggering at least one of the one or more additional operating mode features on the range extender in response to determining that the access point is capable of the one or more additional operating mode features.

21. The range extender of claim 20, wherein the one or more additional operating mode features comprises at least one of access point steering, band steering, multi-backhaul connectivity, and improved roaming.

22. The range extender of claim 15, wherein the processor is further configured with processor-executable instructions to perform operations comprising:
selecting, by the processor, a default operating mode from the plurality of operating modes of the range extender in response to determining that the range extender has not received the interoperability information from the access point.

23. An access point, comprising:
a processor configured with processor-executable instructions to perform operations comprising:
receiving an association request from a range extender; and
transmitting interoperability information to the range extender in response to receiving the association request, wherein the interoperability information indicates at least one operating mode of the access point.

24. The access point of claim 23, wherein the processor is further configured with processor-executable instructions to perform operations such that transmitting interoperability information to the range extender comprises transmitting the interoperability information in an association response message, a probe response, or a beacon frame.

25. The access point of claim 23, wherein the at least one operating mode of the access point comprises a three-address mode and a four-address mode.

26. The access point of claim 23, wherein the processor is further configured with processor-executable instructions to perform operations comprising:
receiving, from the range extender, a selected operating mode of the range extender based on the transmitted interoperability information, wherein the range extender is capable of operating in a plurality of operating modes including the selected operating mode.

27. The access point of claim 23, wherein the interoperability information further indicates one or more additional operating mode features of the access point.

28. The access point of claim 27, wherein the one or more additional operating mode features comprises at least one of access point steering, band steering, multi-backhaul connectivity, and improved roaming.
